(19) United States
(12) Patent Application Publication
(10) Pub. No.: US 2021/0385887 A1
(43) Pub. Date: Dec. 9, 2021

(54) COMMUNICATION METHOD AND DEVICE, AND STORAGE MEDIUM

(71) Applicant: SZ DJI TECHNOLOGY CO., LTD., Shenzhen (CN)

(72) Inventors: Wenyue CHEN, Shenzhen (CN); Xiaojun YIN, Shenzhen (CN)

(21) Appl. No.: 17/411,234

(22) Filed: Aug. 25, 2021

Related U.S. Application Data
(63) Continuation of application No. PCT/CN2019/076531, filed on Feb. 28, 2019.

(51) Int. Cl. H04W 76/10; H04W 4/02; H04W 12/06

(52) U.S. Cl. CPC H04W 76/10; H04W 12/06; H04W 4/02

(57) ABSTRACT

A communication method includes obtaining first communication authentication information of a mobile platform, sending the first communication authentication information to a server for the server to send the first communication authentication information to a base station to be connected, receiving second communication authentication information of the base station to be connected sent by the server, and sending the second communication authentication information to the mobile platform. The first communication authentication information and the second communication authentication information are used to establish a wireless communication connection between the mobile platform and the base station to be connected.

### CROSS-REFERENCE TO RELATED APPLICATION

This application is a continuation of International Application No. PCT/CN2019/076531, filed Feb. 28, 2019, the entire content of which is incorporated herein by reference.

### TECHNICAL FIELD

The present disclosure relates to the field of communication technologies and, more particularly, to a communication method and device, and a storage medium.

### BACKGROUND

With development of wireless control technology, mobile platforms including unmanned aerial vehicles or remote control vehicles have been widely used in production and daily life. For example, unmanned aerial vehicles are used for normal patrol in the security, power, or petroleum industries. By remotely controlling the unmanned aerial vehicles, the unmanned aerial vehicles can collect on-site video information and send it back to control terminals in real-time.

In existing technologies, base stations are usually deployed at high points (such as iron towers, tops of buildings, hills, etc.) with a wide field of vision in work areas of a mobile platform, and the mobile platform is connected to the base stations to increase a control distance of the mobile platform, such that information (such as images, etc.) collected by the mobile platform can be stably received.

Since image/data transmission links of the mobile platforms are usually point-to-point or point-to-multipoint communication, frequency pairing is needed between a mobile terminal and a control terminal for the establishment of a communication link between the mobile platform and the control terminal. The frequency pairing process usually requires the mobile platform and the control terminal to enter a pairing mode in a short distance at the same time before they can exchange authentication information such as communication identifiers or keys. The base station is fixed at a high point and has a large distance from the ground. It is difficult to trigger the base station to enter the frequency pairing mode. The frequency pairing method in the existing technologies is not suitable for the frequency pairing between the mobile platform and the base station.

### SUMMARY

In accordance with the disclosure, there is provided a communication method includes obtaining first communication authentication information of a mobile platform, sending the first communication authentication information to a server for the server to send the first communication authentication information to a base station to be connected, receiving second communication authentication information of the base station to be connected sent by the server, and sending the second communication authentication information to the mobile platform. The first communication authentication information and the second communication authentication information are used to establish a wireless communication connection between the mobile platform and the base station to be connected.

Also in accordance with the disclosure, there is also a communication method including receiving first communication authentication information of a mobile platform sent by a control terminal, sending the first communication authentication information to a base station to be connected, obtaining second communication authentication information of the base station, and sending the second communication authentication information to the control terminal for the control terminal to send the second communication authentication information to the mobile platform. The first communication authentication information and the second communication authentication information are used to establish a wireless communication connection between the mobile platform and the base station.

### BRIEF DESCRIPTION OF THE DRAWINGS

The above and/or additional aspects and advantages of this disclosure will become obvious and easy to understand from the description of the embodiments in conjunction with the following drawings.

FIG. 1 is a schematic flow chart of a communication method consistent with various embodiments of the present disclosure.

FIG. 2 is a schematic flow chart of another communication method consistent with various embodiments of the present disclosure.

FIG. 3 is a schematic flow chart of another communication method consistent with various embodiments of the present disclosure.

FIG. 4 is a schematic flow chart of another communication method consistent with various embodiments of the present disclosure.

FIG. 5 is a schematic flow chart of another communication method consistent with various embodiments of the present disclosure.

FIG. 6 is a schematic flow chart of another communication method consistent with various embodiments of the present disclosure.

FIG. 7 is a schematic flow chart of another communication method consistent with various embodiments of the present disclosure.

FIG. 8 is a schematic flow chart of another communication method consistent with various embodiments of the present disclosure.

FIG. 9 is a schematic flow chart of another communication method consistent with various embodiments of the present disclosure.

FIG. 10 is a schematic flow chart of another communication method consistent with various embodiments of the present disclosure.

FIG. 11 is a schematic flow chart of another communication method consistent with various embodiments of the present disclosure.

FIG. 12 shows an exemplary control terminal consistent with various embodiments of the present disclosure.

FIG. 13 shows an exemplary server consistent with various embodiments of the present disclosure.

FIG. 14 shows an exemplary mobile platform consistent with various embodiments of the present disclosure.

FIG. 15 shows an exemplary base station consistent with various embodiments of the present disclosure.

FIG. 16 shows an exemplary communication system consistent with various embodiments of the present disclosure.

### DETAILED DESCRIPTION OF THE EMBODIMENTS

Technical solutions of the present disclosure will be described with reference to the drawings. It will be appreciated that the described embodiments are part rather than all of the embodiments of the present disclosure. Other embodiments conceived by those having ordinary skills in the art on the basis of the described embodiments without inventive efforts should fall within the scope of the present disclosure.

It should be noted that when a component is referred to as being “fixed to” another component, it can be directly on the other component or a component between them may also exist. When a component is considered to be “connected” to another component, it can be directly connected to the other component or a component between them may also exist.

Unless otherwise defined, all technical and scientific terms used herein have the same meaning as commonly understood by those skilled in the technical field of the present disclosure. The terms used in the description of the present disclosure herein are only for the purpose of describing specific embodiments, and are not intended to limit the present disclosure. The term “and/or” as used herein includes any and all combinations of one or more related listed items.

In the following, some embodiments of the present disclosure will be described in detail with reference to the accompanying drawings. In the case of no conflict, the following embodiments and features in the embodiments can be combined with each other.

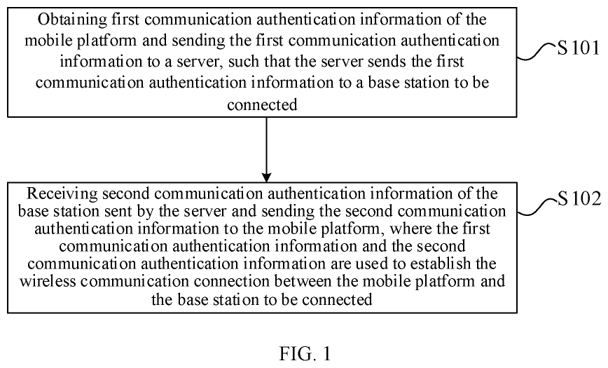

The present disclosure provides a communication method. In one embodiment, the communication method may be executed by a control terminal, and the control terminal may be connected to a mobile platform by communication. As shown in FIG. 1, the method includes S101 and S102.

At S101, first communication authentication information of the mobile platform is obtained, and the first communication authentication information is sent to a server, such that the server can send the first communication authentication information to a base station to be connected.

An execution subject of the method in this embodiment may be the control terminal. The control terminal may be a remote control, a smartphone, a tablet computer, a notebook computer, a smart wearable device, a ground control station, or a combination thereof, used to control the mobile platform. The mobile platform may include but is not limited to, unmanned aerial vehicles or remote control vehicles. The control terminal and the mobile platform can establish a communication connection in advance, for example, through an existing frequency pairing method.

In the present embodiment, the control terminal may obtain the first communication authentication information of the mobile platform. The first communication authentication information may include, but is not limited to, identity and/or communication key of the mobile platform. More specifically, the control terminal may obtain the first communication authentication information from the mobile platform; or may store the first communication authentication information of the mobile platform in a local storage device of the control terminal in advance, and obtain the first communication authentication information of the mobile platform from the local storage device. Further, after the control terminal obtains the first communication authentication information of the mobile platform, the first communication authentication information may be sent to the server, such that the server can send the first communication authentication information to the base station to be connected after receiving the first communication authentication information. The base station to be connected may be a base station that needs to establish a wireless communication connection with the mobile platform such that the base station can receive sensor data collected by the mobile platform through the wireless communication connection and/or the base station can directly send control instructions to the mobile platform. In this embodiment, the server and the base station may be connected through a wired network such as coaxial cables, twisted pairs, or optical fibers. In some other embodiments, the server and the base station may be connected through a wireless network such as a cellular communication network or a wireless local area network.

At S102, second communication authentication information of the base station sent by the server is received, and the second communication authentication information is sent to the mobile platform. The first communication authentication information and the second communication authentication information are used to establish the wireless communication connection between the mobile platform and the base station.

In the present embodiment, the server may obtain the second communication authentication information of the base station to be connected. Similarly, the second communication authentication information may include, but is not limited to, identity and/or communication key of the base station. More specifically, the server may obtain the second communication authentication information from the base station; or may store the second communication authentication information of the base station in the server's local storage device in advance, and obtain the second communication authentication information of the base station from the local storage device. Further, after obtaining the second communication authentication information of the base station to be connected, the server may send the second communication authentication information to the control terminal, and the control terminal may send the second communication authentication information to the mobile platform. Through the above processes, the exchange of communication authentication information between the mobile platform and the base station to be connected may be realized. Further, through the first communication authentication information and the second communication authentication information, the wireless communication connection can be established between the mobile platform and the base station. The wireless communication connection established between the mobile platform and the base station may be a point-to-point wireless two-way communication link.

The communication method provided in this embodiment does not limit the sequence of execution of S101 and S102.

In the communication method provided in the present disclosure, the first communication authentication information of the mobile platform may be obtained by the control terminal, and then may be sent to the server, such that the server can send the first communication authentication information to the base station to be connected. The server may send the second communication authentication information of the base station to the control terminal, and the control terminal may then send the second communication authentication information to the mobile platform, to realize the exchange of communication authentication information between the mobile platform and the base station to be connected. The first communication authentication information and the second communication authentication information may be used for the establishment of the wireless communication connection between the mobile platform and the base station, facilitating frequency pairing between the mobile platform and the base station deployed at a high point. Correspondingly, the mobile platform can operate in a large fixed area and the convenience may be greatly improved.

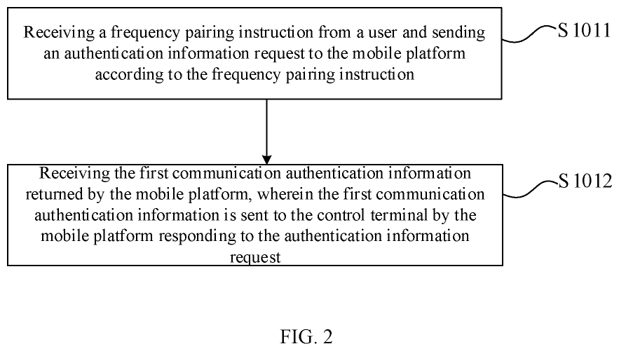

Based on any of the previous embodiments, in one embodiment, as shown in FIG. 2, obtaining the first communication authentication information of the mobile platform (S101) includes:

S1011: receiving a frequency pairing instruction from a user and sending an authentication information request to the mobile platform according to the frequency pairing instruction; and

S1012: receiving the first communication authentication information returned by the mobile platform, where the first communication authentication information is sent to the control terminal by the mobile platform responding to the authentication information request.

In this embodiment, the user can trigger frequency pairing between the mobile platform and the base station on the control terminal. For example, the user may click the frequency pairing button on an interactive interface of the control terminal. After receiving the user's frequency pairing instruction, the control terminal may send the authentication information request to the mobile platform communicatively connected with the control terminal according to the frequency pairing instruction. After receiving the authentication information request, the mobile platform may send the first communication authentication information of the mobile platform to the control terminal by responding to the authentication information request.

Based on previous embodiments, in one embodiment, sending the first communication authentication information to the server at S101 may include sending the first communication authentication information to the server through a mobile communication network, and receiving the second communication authentication information of the base station obtained by the server at S102 may include receiving the second communication authentication information of the base station obtained by the server through a mobile communication network.

In the various embodiments of the present disclosure, the communication connection between the control terminal and the server may adopt a mobile communication network. The mobile communication network may include a cellular communication network, specifically including but not limited to Global System of Mobile communication (GSM), Code Division Multiple Access (CDMA), Wideband Code Division Multiple Access (WCDMA), Time Division-Synchronous Code Division Multiple Access (TD-SCDMA), Long Term Evolution (LTE), or the fifth-generation mobile communication network (5G). Through the mobile communication network, the exchange of the first communication authentication information and the second communication authentication information between the control terminal and the server can be realized, such that the mobile platform and the base station can obtain the communication authentication information of the other party more conveniently.

Based on any of the previous embodiments, in one embodiment, there may be a plurality of candidate base stations and the base station to be connected needs to be determined first according to the following implementation.

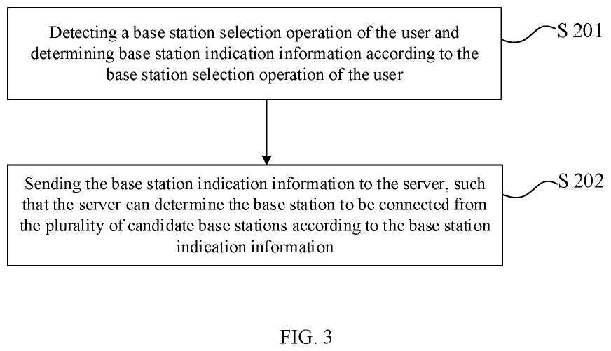

In one embodiment, as shown in FIG. 3, determining the base station to be connected includes S201 and S202.

At S201, a base station selection operation of the user is detected and base station indication information is determined according to the base station selection operation of the user.

In the present embodiment, the user may select the base station to be connected through the control terminal. After detecting the base station selection operation of the user, the control terminal may determine the base station indication information including a serial number or position information of the base station, according to the base station selection operation of the user.

Specifically, the control terminal can control the display of identifiers of one or more candidate base stations on the interactive interface of the control terminal, and detect the user's base station selection operation on the interactive interface, such as detecting the base station whom the user clicks on the interactive interface, or receiving the base station information entered by the user in the interactive interface (such as the base station's serial number, position information, etc.).

At S202, the base station indication information is sent to the server, such that the server can determine the base station to be selected from the plurality of candidate base stations according to the base station indication information.

In the present disclosure, the control terminal may send the base station indication information to the server, and the server can determine the base station corresponding to the base station indication information among the plurality of candidate base stations as the base station to be connected according to the base station indication information.

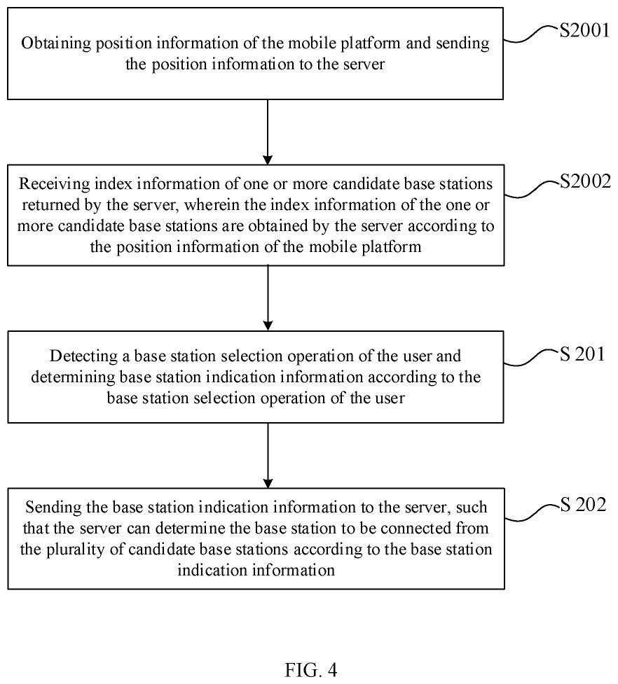

In some embodiments, as shown in FIG. 4, before detecting the base station selection operation of the user at S201, the method further includes:

S2001: obtaining the position information of the mobile platform and send the position information to the server; and

S2002: receiving index information of one or more candidate base stations returned by the server, where the index information of the one or more candidate base stations is obtained by the server according to the position information of the mobile platform.

In the present disclosure, to facilitate the mobile platform to establish a stable and reliable wireless communication connection with the base station, the one or more candidate base stations can be determined according to the position information of the mobile platform. For example, the one or more candidate base stations may include base stations within a predetermined radius area centered on the position of the mobile platform. In this embodiment, the position information of the mobile platform can be obtained through the control terminal and may be sent to the server. The server may obtain the index information of the one or more candidate base stations according to the position information of the mobile platform. The index information may include but is not limited to, one or more of the serial numbers, position information, or the type of the base station. The index information may be specifically obtained from a local storage device of the server. Of course, in some other embodiments, the server can also request the index information from the one or more candidate base stations. Furthermore, the server may send the index information of the one or more candidate base stations to the control terminal to facilitate the user to perform the base station selection operation.

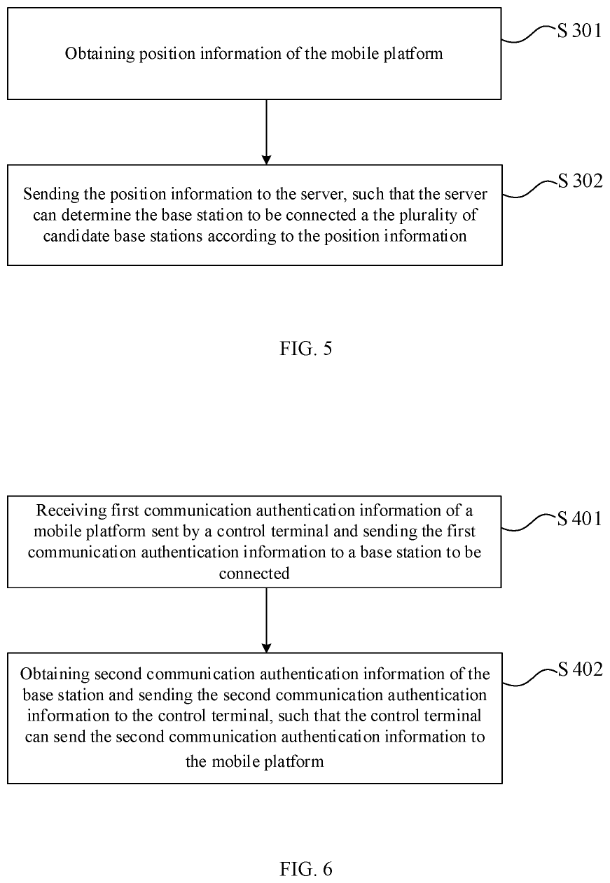

In another embodiment, as shown in FIG. 5, determining the base station to be connected includes:

S301: obtaining the position information of the mobile platform; and

S302: sending the position information to the server such that the server can determine the base station to be connected from the plurality of candidate base stations according to the position information.

In this embodiment, the server can automatically select the base station to be connected according to the position information of the mobile platform. That is, after the control terminal obtains the position information of the mobile platform, it may send the position information of the mobile platform to the server. According to the position information of the mobile platform, the base station to be connected may be determined from the plurality of candidate base stations. More specifically, the server can determine one base station of the plurality of candidate base stations within the smallest distance from the mobile platform according to the position information of the mobile platform, therefore ensuring a stable and reliable wireless communication connection can be established between the mobile platform and the base station.

The present disclosure provides another communication method. The execution subject of the communication method can be, e.g., a server. As shown in FIG. 6, the communication method includes S401 and S402.

At S401, first communication authentication information sent by a control terminal is received and the received first communication authentication information is sent to a base station to be connected.

In this embodiment, the control terminal may obtain the first communication authentication information of the mobile platform. Specifically, the first communication authentication information may be obtained from the mobile platform or from a local storage device. The first communication authentication information may include, but is not limited to, identity and/or communication key of the mobile platform. Then the control terminal may send the first communication authentication information to the server, and the server may send the first communication authentication information to the base station to be connected after receiving the first communication authentication information. The server and the base station to be connected can be connected through a wired network such as coaxial cable, twisted pair, or optical fiber, and of course, can also be connected through a wireless network such as a cellular communication network or a wireless local area network. The mobile platform in this embodiment may include, but is not limited to, unmanned aerial vehicles or remote control vehicles.

At S402, second communication authentication information of the base station is obtained and sent to the control terminal such that the control terminal can send the second communication authentication information to the mobile platform. The first communication authentication information and the second communication authentication information are used to establish the wireless communication connection between the mobile platform and the base station.

In the present embodiment, the server may obtain the second communication authentication information of the base station to be connected. Similarly, the second communication authentication information may include, but is not limited to, identity and/or communication key of the base station. More specifically, the server may obtain the second communication authentication information from the base station; or may store the second communication authentication information of the base station in the server's local storage device in advance, and obtain the second communication authentication information of the base station from the local storage device. Further, after obtaining the second communication authentication information of the base station to be connected, the server may send the second communication authentication information to the control terminal, and the control terminal may send the second communication authentication information to the mobile platform. Through the above processes, the exchange of communication authentication information between the mobile platform and the base station to be connected may be realized. Further, through the first communication authentication information and the second communication authentication information, the wireless communication connection can be established between the mobile platform and the base station. The wireless communication connection established between the mobile platform and the base station may be a point-to-point wireless two-way communication link.

The communication method provided in this embodiment does not limit the sequence of execution of S401 and S402.

In the communication method provided in the present disclosure, the first communication authentication information of the mobile platform may be obtained by the control terminal, and then may be sent to the server, such that the server can send the first communication authentication information to the base station to be connected. The server may send the second communication authentication information of the base station to the control terminal, and the control terminal may then send the second communication authentication information to the mobile platform, to realize the exchange of communication authentication information between the mobile platform and the base station to be connected. The first communication authentication information and the second communication authentication information may be used for the establishment of the wireless communication connection between the mobile platform and the base station, facilitating frequency pairing between the mobile platform and the base station deployed at a high point. Correspondingly, the mobile platform can operate in a large fixed area and the convenience may be greatly improved.

Based on previous embodiments, in one embodiment, receiving the first communication authentication information sent by the control terminal at S401 may include receiving the first communication authentication information sent by the control terminal through a mobile communication network, and sending the second communication authentication information of the base station to the control terminal at S402 may include sending the second communication authentication information of the base station to the control terminal through a mobile communication network.

In the various embodiments of the present disclosure, the communication connection between the control terminal and the server may adopt a mobile communication network. The mobile communication network may include a cellular communication network, specifically including but not limited to Global System of Mobile communication (GSM), Code Division Multiple Access (CDMA), Wideband Code Division Multiple Access (WCDMA), Time Division-Synchronous Code Division Multiple Access (TD-SCDMA), Long Term Evolution (LTE), or the fifth-generation mobile communication network (5G). Through the mobile communication network, the exchange of the first communication authentication information and the second communication authentication information between the control terminal and the server can be realized, such that the mobile platform and the base station can obtain the communication authentication information of the other party more conveniently.

Based on any of the previous embodiments, in one embodiment, there may be a plurality of candidate base stations and the base station to be connected needs to be determined first according to the following implementation.

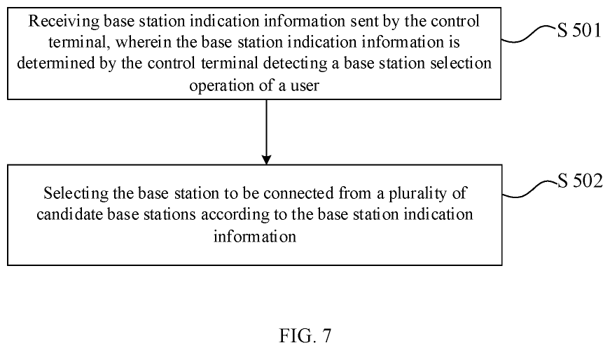

In one embodiment, as shown in FIG. 7, determining the base station to be connected includes:

S501: receiving base station indication information sent by the control terminal, where the base station indication information is determined by the control terminal detecting a base station selection operation of a user; and

S502: selecting the base station to be connected from the plurality of candidate base stations according to the base station indication information.

In the present embodiment, the user may select the base station to be connected through the control terminal. After detecting the base station selection operation of the user, the control terminal may determine the base station indication information including a serial number or position information of the base station, according to the base station selection operation of the user. The control terminal may send the base station indication information to the server, and the server can determine one base station of the plurality of candidate base stations corresponding to the base station indication information as the base station to be connected, according to the base station indication information.

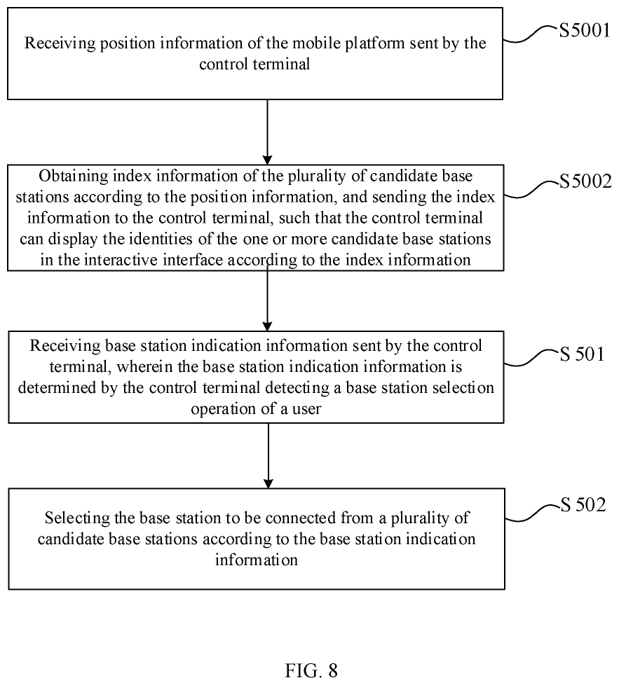

In some embodiments, as shown in FIG. 8, before receiving the base station indication information sent by the control terminal at S501, the method further includes:

S5001: receiving position information of the mobile platform sent by the control terminal; and

S5002: obtaining index information of one or more candidate base stations and sending the index information to the control terminal, such that the control terminal can display the identity of the one or more candidate base stations in an interactive interface according to the index information.

In the present disclosure, the position information of the mobile platform may be obtained through the control terminal and sent to the server. The server may obtain the index information of the one or more candidate base stations according to the position information of the mobile platform. The index information may include but is not limited to, one or more of the serial numbers, position information, or the type of the base station. The index information may be specifically obtained from a local storage device of the server. Of course, in some other embodiments, the server can also request the index information from the one or more candidate base stations. Furthermore, the server may send the index information of the one or more candidate base stations to the control terminal to facilitate the user to perform the base station selection operation.

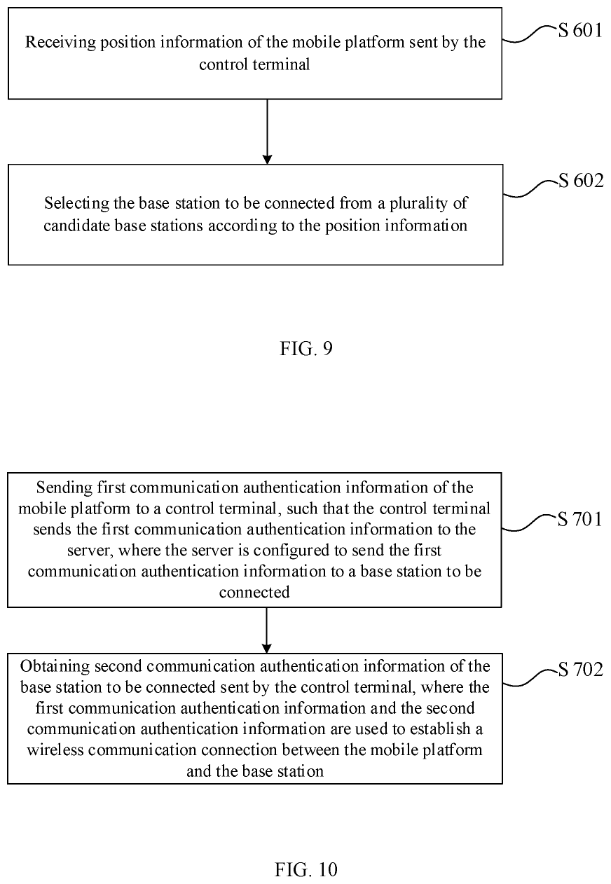

In another embodiment, as shown in FIG. 9, determining the base station to be connected includes:

S601: receiving the position information of the mobile platform sent by the control terminal; and

S602: determining the base station to be connected from the plurality of candidate base stations according to the position information.

In this embodiment, the server can automatically select the base station to be connected according to the position information of the mobile platform. That is, after the control terminal obtains the position information of the mobile platform, it may send the position information of the mobile platform to the server. According to the position information of the mobile platform, the base station to be connected may be determined from the plurality of candidate base stations. More specifically, the server can determine one base station of the plurality of candidate base stations within the smallest distance from the mobile platform according to the position information of the mobile platform, therefore ensuring a stable and reliable wireless communication connection can be established between the mobile platform and the base station.

Based on any of the previous embodiments, in one embodiment, after establishing the wireless communication link between the mobile platform and the base station, the method may further include: sending a control instruction for the mobile platform to the base station, such that the base station can send the control instruction to the mobile platform through the wireless communication link.

In the present embodiment, after establishing the wireless communication link between the mobile platform and the base station, the mobile platform may be controlled through the base station, and the control instruction sent to the mobile platform from the base station may be sent through the server. The server can be located in a control center, and control personnel of the control center may send a control instruction to the server. In addition, the user on the control terminal side can also send the control instruction to the server through the control terminal to increase the remote control distance of the mobile platform.

Based on any of the previous embodiments, in one embodiment, after establishing the wireless communication link between the mobile platform and the base station, the method may further include: obtaining sensor data captured by the mobile platform from the base station. The sensor data may be obtained by the base station from the mobile platform through the wireless communication link.

In the present embodiment, after establishing the wireless communication link between the mobile platform and the base station, the sensor data captured by the mobile platform (such as image data) may be sent directly to the base station by the mobile platform through the wireless communication link, and then may be sent to the server by the base station. Correspondingly, the server may process the sensor data captured by the mobile platform in real-time, to realize tasks including patrol or monitoring.

Another embodiment of the present disclosure shown in FIG. 10 provides another communication method. The execution subject of the communication method can be, e.g., a mobile platform. As shown in FIG. 10, the method includes:

S701: sending first communication authentication information of the mobile platform to a control terminal, such that the control terminal sends the first communication authentication information to the server, where the server is configured to send the first communication authentication information to a base station to be connected; and

S702: obtaining second communication authentication information of the base station to be connected sent by the control terminal.

The second communication authentication information may be obtained by the control terminal from the server. The first communication authentication information and the second communication authentication information may be used to establish a wireless communication connection between the mobile platform and the base station.

In the present embodiment, the method is the communication method at the mobile platform side according to the communication method provided by previous embodiments. The principle and implementation are similar to previous embodiments.

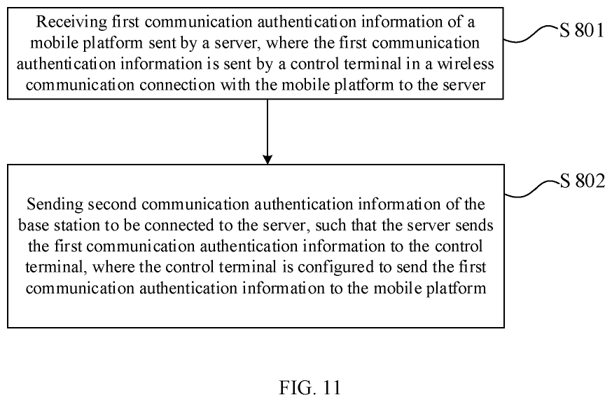

Another embodiment of the present disclosure shown in FIG. 11 provides another communication method. The execution subject of the communication method can be, for example, a base station. As shown in FIG. 11, the method includes:

S801: receiving first communication authentication information of a mobile platform sent by a server, where the first communication authentication information is sent by a control terminal in a wireless communication connection with the mobile platform to the server; and

S802: sending second communication authentication information of the base station to be connected to the server, such that the server sends the first communication authentication information to the control terminal.

The control terminal is configured to send the first communication authentication information to the mobile platform. The first communication authentication information and the second communication authentication information may be used to establish a wireless communication connection between the mobile platform and the base station.

In the present embodiment, the method is the communication method at the base station side according to the communication method provided by previous embodiments. The principle and implementation are similar to previous embodiments.

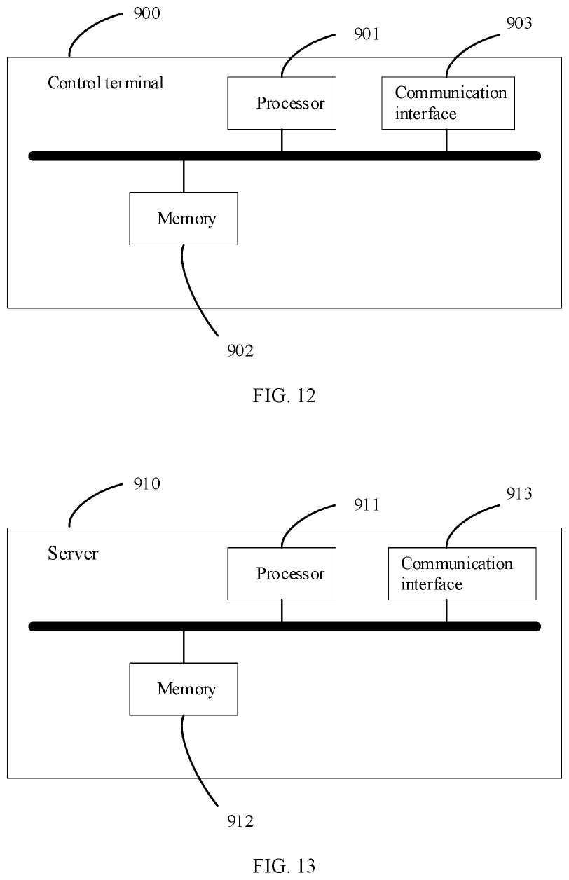

The present disclosure also provides a control terminal. As shown in FIG. 12, in one embodiment, the control terminal 900 includes a memory 902 and a processor 901.

The memory 902 is configured to store program codes.

The processor 901 is configured to execute the program codes. When the program codes are executed, the processor 901 is configured to:

obtain first communication authentication information of a mobile platform and send the first communication authentication information to a server, such that the server sends the first communication authentication information to a base station to be connected; and

receive second communication authentication information of the base station sent by the server, and send the second communication authentication information to the mobile platform.

The first communication authentication information and the second communication authentication information may be used to establish a wireless communication connection between the mobile platform and the base station.

Further, when the processor 901 is configured to obtain the first communication authentication information of the mobile platform, the processor 901 may be configured to:

receive a frequency pairing instruction from a user and send an authentication information request to the mobile platform according to the frequency pairing instruction; and

receive the first communication authentication information returned by the mobile platform, where the first communication authentication information is sent to the control terminal by the mobile platform responding to the authentication information request.

Based on previous embodiments, in one embodiment, when the processor 901 is configured to send the first communication authentication information to the server, the processor 901 may be configured to send the first communication authentication information to the server through a mobile communication network. When the processor 901 is configured to receive the second communication authentication information of the base station obtained by the server, the processor 901 may be configured to receive the second communication authentication information of the base station obtained by the server through a mobile communication network.

Based on previous embodiments, the processor 901 may be further configured to:

detect a base station selection operation of the user and determine base station indication information according to the base station selection operation of the user; and

send the base station indication information to the server, such that the server can determine the base station to be selected from a plurality of candidate base stations according to the base station indication information.

The processor 901 may be further configured to: control an interactive interface of the control terminal to display identities of one or more candidate base stations.

When the processor 901 is configured to detect the base station selection operation of the user, the processor 901 may be configured to: detect the base station selection operation of the user in the interactive interface.

Further, before detecting the base station selection operation of the user, the processor 901 may be configured to:

obtain position information of the mobile platform; and

send the position information to the server such that the server can determine the base station to be connected from the plurality of candidate base stations according to the position information.

Further, the base station to be connected may be one of the plurality of candidate base stations with a smallest distance from the mobile platform determined by the server.

The first communication authentication information may include, but is not limited to, identity and/or communication key of the mobile platform. The second communication authentication information may include, but is not limited to, identity and/or communication key of the base station.

The mobile platform may include at least one of an unmanned aerial vehicle or a remote control vehicle.

In one embodiment, the control terminal 900 may further include a communication interface 903. The information interaction between the processor 901 and the server or the mobile platform may be achieved through the communication interface 903 controlled by the processor 901.

In the present disclosure, the control terminal obtains the first communication authentication information of the mobile platform, and sends the first communication authentication information to the server, such that the server sends the first communication authentication information to the base station to be connected. The server sends the second communication authentication information of the base station to the control terminal and the control terminal sends the second communication authentication information to the mobile platform, to realize the exchange of communication authentication information between the mobile platform and the base station to be connected. Through the first authentication information and the second authentication information, the wireless communication connection can be established between the mobile platform and the base station, which facilitates frequency pairing between the mobile platform and the base station deployed at a high point. The convenience of the mobile platform in a large-scale fixed area operation may be greatly improved.

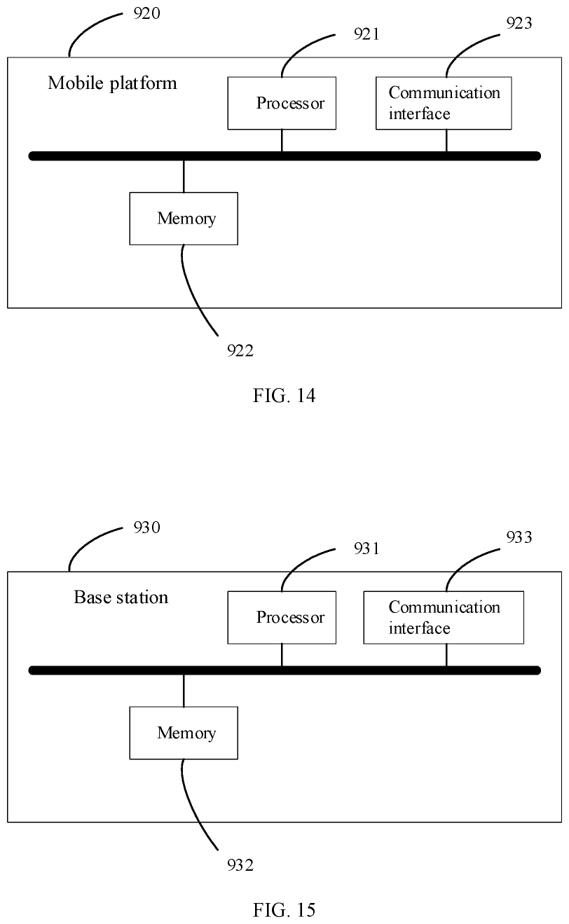

The present disclosure also provides a mobile platform. In one embodiment, as shown in FIG. 14, the mobile platform 920 includes a memory 922 and a processor 921.

The memory 922 is configured to store program codes.

The processor 921 is configured to execute the program codes. When the program codes are executed, the processor 901 is configured to:

send first communication authentication information of the mobile platform to the control terminal such that the control terminal sends the first communication authentication information to a server, where the server is configured to send the first communication authentication information to a base station to be connected; and

obtain second communication authentication information of the base station to be connected sent by the control terminal, where the second communication authentication information is obtained by the control terminal from the server.

The first communication authentication information and the second communication authentication information may be used to establish a wireless communication connection between the mobile platform and the base station.

In one embodiment, the control terminal 920 may further include a communication interface 923. The information interaction between the processor 921 and the control terminal or the base station may be achieved through the communication interface 923 controlled by the processor 921.

In the present disclosure, the control terminal obtains the first communication authentication information of the mobile platform, and sends the first communication authentication information to the server, such that the server sends the first communication authentication information to the base station to be connected. The server sends the second communication authentication information of the base station to the control terminal and the control terminal sends the second communication authentication information to the mobile platform, to realize the exchange of communication authentication information between the mobile platform and the base station to be connected. Through the first authentication information and the second authentication information, the wireless communication connection can be established between the mobile platform and the base station, which facilitates frequency pairing between the mobile platform and the base station deployed at a high point. The convenience of the mobile platform in a large-scale fixed area operation may be greatly improved.

The present disclosure also provides a base station. In one embodiment, as shown in FIG. 15, the base station 930 includes a memory 932 and a processor 931.

The memory 932 is configured to store program codes.

The processor 931 is configured to execute the program codes. When the program codes are executed, the processor 931 is configured to:

receive first communication authentication information of the mobile platform sent by the server, where the first communication authentication information is sent to the server by the control terminal in a communication connection with the mobile platform; and

send second communication authentication information of the base station to be connected to the server such that the server sends the first communication authentication information to the control terminal, where the control terminal is configured to send the first communication authentication information to the mobile platform.

The first communication authentication information and the second communication authentication information may be used to establish a wireless communication connection between the mobile platform and the base station.

In one embodiment, the control terminal 930 may further include a communication interface 933. The information interaction between the processor 931 and the control terminal or the base station may be achieved through the communication interface 933 controlled by the processor 931.

In the present disclosure, the control terminal obtains the first communication authentication information of the mobile platform, and sends the first communication authentication information to the server, such that the server sends the first communication authentication information to the base station to be connected. The server sends the second communication authentication information of the base station to the control terminal and the control terminal sends the second communication authentication information to the mobile platform, to realize the exchange of communication authentication information between the mobile platform and the base station to be connected. Through the first authentication information and the second authentication information, the wireless communication connection can be established between the mobile platform and the base station, which facilitates frequency pairing between the mobile platform and the base station deployed at a high point. The convenience of the mobile platform in a large-scale fixed area operation may be greatly improved.

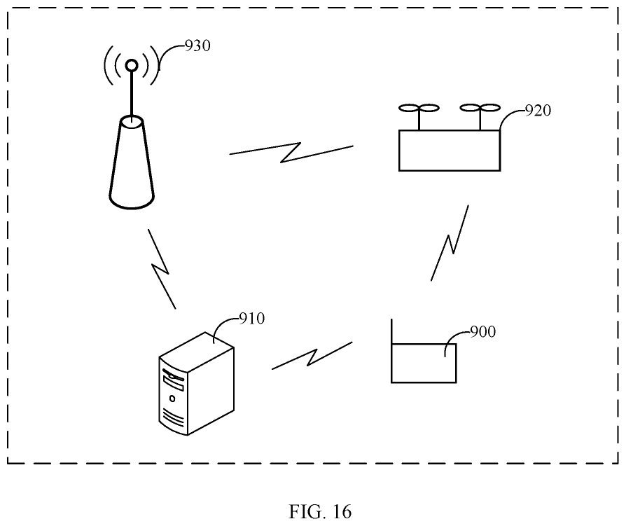

The present disclosure also provides a communication system. As shown in FIG. 16, in one embodiment, the communication system includes a control terminal 900, a server 910, a mobile platform 920, and a base station 930, provided by various embodiments of the present disclosure.

The principle and implementation of the communication system are similar to previous embodiments.

In the present disclosure, the control terminal obtains the first communication authentication information of the mobile platform, and sends the first communication authentication information to the server, such that the server sends the first communication authentication information to the base station to be connected. The server sends the second communication authentication information of the base station to the control terminal and the control terminal sends the second communication authentication information to the mobile platform, to realize the exchange of communication authentication information between the mobile platform and the base station to be connected. Through the first authentication information and the second authentication information, the wireless communication connection can be established between the mobile platform and the base station, which facilitates frequency pairing between the mobile platform and the base station deployed at a high point. The convenience of the mobile platform in a large-scale fixed area operation may be greatly improved.

The present disclosure also provides a computer-readable storage medium. The computer-readable storage medium is configured to store a computer program. The computer program is configured to be executed to achieve a communication method at a control terminal end provided by various embodiments of the present disclosure.

The present disclosure also provides another computer-readable storage medium. The computer-readable storage medium is configured to store a computer program. The computer program is configured to be executed to achieve a communication method at a server end provided by various embodiments of the present disclosure.

The present disclosure also provides another computer-readable storage medium. The computer-readable storage medium is configured to store a computer program. The computer program is configured to be executed to achieve a communication method at a mobile platform end provided by various embodiments of the present disclosure.

The present disclosure also provides another computer-readable storage medium. The computer-readable storage medium is configured to store a computer program. The computer program is configured to be executed to achieve a communication method at a base station end provided by various embodiments of the present disclosure.

In the present disclosure, the devices or the methods provided by various embodiments of the present disclosure may be achieved by other methods. For example, the device embodiments described above are only illustrative. For example, the division of the units is only a logical function division, and there may be other divisions in actual implementation. For example, multiple units or components can be combined or can be integrated into another system, or some features can be ignored or not implemented. In addition, the displayed or discussed mutual coupling or direct coupling or communication connection may be indirect coupling or communication connection through some interfaces, devices or units, and may be in electrical, mechanical or other forms.

The units described as separate components may or may not be physically separated, and the components displayed as units may or may not be physical units. That is, they may be located in one place, or they may be distributed on multiple network units. Some or all of the units may be selected according to actual needs to achieve the objectives of the solutions of the embodiments.

In addition, the functional units in the various embodiments of the present disclosure may be integrated into one processing unit, or each unit may exist alone physically, or two or more units may be integrated into one unit. The above-mentioned integrated units may be implemented in the form of hardware, or may be implemented in the form of hardware plus software functional units.

The above-mentioned integrated unit implemented in the form of a software functional unit may be stored in a computer readable storage medium. The above-mentioned software functional unit may be stored in a storage medium and include several instructions to make a computer device (which may be a personal computer, a server, or a network device, etc.) or a processor execute the methods described in the various embodiments of the present disclosure. The aforementioned storage medium may include: a flash memory, a mobile hard disk, a read-only memory (ROM), a random access memory (RAM), a magnetic disk, an optical disk, or other media that can store program codes.

Those skilled in the art can clearly understand that, for the convenience and conciseness of the description, only the division of the above-mentioned functional modules is used as an example. In practical applications, the above-mentioned functions can be allocated by different functional modules as required. That is, the internal structure of the device may be divided into different functional modules to complete all or part of the functions described above. For the specific working process of the device described above, reference may be made to the corresponding process in the foregoing method embodiments, which is not repeated here.

The above embodiments are only used to illustrate the technical solutions of the present disclosure, not to limit them. Other embodiments of the disclosure will be apparent to those skilled in the art from consideration of the specification and practice of the embodiments disclosed herein. It is intended that the specification and examples be considered as examples only and not to limit the scope of the disclosure, with a true scope and spirit of the invention being indicated by the following claims.

What is claimed is:

1. A communication method comprising:
obtaining first communication authentication information of a mobile platform;
sending the first communication authentication information to a server for the server to send the first communication authentication information to a base station to be connected;
receiving second communication authentication information of the base station to be connected sent by the server; and
sending the second communication authentication information to the mobile platform;
wherein the first communication authentication information and the second communication authentication information are used to establish a wireless communication connection between the mobile platform and the base station to be connected.

2. The method according to claim 1, wherein obtaining the first communication authentication information of the mobile platform includes:
receiving a frequency pairing instruction;
sending an authentication information request to the mobile platform according to the frequency pairing instruction; and
receiving the first communication authentication information returned by the mobile platform responding to the authentication information request.

3. The method according to claim 1, wherein:
sending the first communication authentication information to the server includes sending the first communication authentication information to the server through a mobile communication network; and
receiving the second communication authentication information of the base station sent by the server includes receiving the second communication authentication information of the base station sent by the server through the mobile communication network.

4. The method according to claim 1, further comprising:
detecting a base station selection operation;
determining base station indication information according to the base station selection operation; and
sending the base station indication information to the server for the server to determine the base station to be connected from a plurality of candidate base stations according to the base station indication information.

5. The method according to claim 4, further comprising:
controlling an interactive interface of a control terminal to display an identity of each of one or more candidate base stations;
wherein detecting the base station selection operation includes detecting the base station selection operation on the interactive interface.

6. The method according to claim 4, further comprising, before detecting the base station selection operation:
obtaining position information of the mobile platform;
sending the position information to the server;
receiving index information of one or more candidate base stations returned by the server, the index information of the one or more candidate base stations being obtained by the server according to the position information of the mobile platform.

7. The method according to claim 1, further comprising:
obtaining position information of the mobile platform; and
sending the position information to the server for the server to determine the base station to be connected from a plurality of candidate base stations according to the position information.

8. The method according to claim 7, wherein:
the base station to be connected is determined by the server according to the position information of the mobile platform to be one base station that is closest to the mobile platform among the plurality of candidate base stations.

9. The method according to claim 1, wherein:
the first communication authentication information includes at least one of an identity or a communication key of the mobile platform; and
the second communication authentication information includes at least one of an identity or a communication key of the base station.

10. The method according to claim 1, wherein:
the mobile platform includes at least one of unmanned aerial vehicle or a remote control vehicle.

11. A communication method comprising:
receiving first communication authentication information of a mobile platform sent by a control terminal;
sending the first communication authentication information to a base station to be connected;
obtaining second communication authentication information of the base station; and
sending the second communication authentication information to the control terminal for the control terminal to send the second communication authentication information to the mobile platform;
wherein the first communication authentication information and the second communication authentication information are used to establish a wireless communication connection between the mobile platform and the base station.

12. The method according to claim 11, wherein:
receiving the first communication authentication information of the mobile platform sent by the control terminal includes receiving the first communication authentication information of the mobile platform sent by the control terminal through a mobile communication network; and
sending the second communication authentication information of the base station to the control terminal includes sending the second communication authentication information of the base station to the control terminal through the mobile communication network.

13. The method according to claim 11, wherein obtaining the second communication authentication information of the base station includes:
obtaining the second communication authentication information from the base station; or
obtaining the second communication authentication information of the base station from a local storage device.

14. The method according to claim 11, further comprising:
receiving base station indication information sent by the control terminal, the base station indication information being determined by the control terminal detecting a base station selection operation; and
selecting the base station to be connected from a plurality of candidate base stations according to the base station indication information.

15. The method according to claim 14, wherein:
wherein:
the control terminal includes an interactive interface for displaying an identity of one or more candidate base stations; and
the base station indication information is determined by the control terminal by detecting the base station selection operation in the interactive interface;
the method further comprising, before receiving the base station indication information sent by the control terminal:
receiving position information of the mobile platform sent by the control terminal;
obtaining index information of the one or more candidate base stations according to the position information; and
sending the index information to the control terminal for the control terminal to display the identity of each of the one or more candidate base stations in the interactive interface according to the index information.

16. The method according to claim 11, further comprising:
receiving position information of the mobile platform sent by the control terminal; and
selecting the base station to be connected from a plurality of candidate base stations according to the position information.

17. The method according to claim 16, wherein selecting the base station to be connected from the plurality of candidate base stations according to the position information includes:
obtaining a distance of each of the plurality of candidate base stations from the mobile platform according to the position information; and
determining one candidate base station that is closest to the mobile platform among the plurality of candidate base stations as the base station to be connected.

18. The method according to claim 11, further comprising, after the wireless communication link between the mobile platform and the base station is established:
sending a control instruction for the mobile platform to the base station, for the base station to send the control instruction to the mobile platform through the wireless communication link.

19. The method according to claim 11, further comprising, after the wireless communication link between the mobile platform and the base station is established:
obtaining, from the base station, sensor data captured by the mobile platform, the sensor data being obtained by the base station from the mobile platform through the wireless communication link.

20. The method according to claim 11, wherein:
the mobile platform includes at least one of an unmanned aerial vehicle or a remote control vehicle.
